(19) United States
(12) Patent Application Publication
(10) Pub. No.: US 2010/0034994 A1
(43) Pub. Date: Feb. 11, 2010

(54) INK-JET RECORDING MEDIUM

(75) Inventors: Kazuhito Hori, Nagano-ken (JP); Kenichi Endo, Nagano-ken (JP); Kazuhiko Yamamoto, Nagano-ken (JP); Junichi Iida, Nagano-ken (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Seiko Epson Corporation, Tokyo (JP)

(21) Appl. No.: 11/992,917

(22) PCT Filed: Oct. 2, 2006
(86) PCT No.: PCT/JP2006/320144

§ 371 Date: Oct. 1, 2009

(30) Foreign Application Priority Data
Sep. 30, 2005 (JP) 2005-286417

(51) Int. Cl. B41M 5/52; B41M 5/50

(52) U.S. Cl. 428/32.18

(57) ABSTRACT

An ink-jet recording medium which comprises: a resin-coated paper comprising a base paper and resin layers with which both surfaces of the base paper are coated, respectively; and an ink-receiving layer formed by coating on one of the resin layers, the ink-receiving layer containing an inorganic particle and a binder for the inorganic particle and the inorganic particle being made of alumina, wherein the base paper has a thickness of 100 to 300 μm and the thickness ratio of one of the resin layers that is located between the base paper and the ink-receiving layer to the other resin layer is as follows: (the one resin layer):(the other resin layer)=1:1 to 1:2.

### TECHNICAL FIELD

The present invention relates to a recording medium for ink-jet recording. More specifically, it relates to an ink-jet recording medium capable of providing high-quality printed matter and excellent in conveying property on a printer.

### BACKGROUND ART

Ink-jet method is a printing method wherein droplets of ink are ejected and deposited on recording media, such as paper, to record images. As ink-jet recording media, conventional wood free paper and coated paper may be used but, in order to obtain high-quality printed matter comparable to images produced by silver salt photography, it is necessary to use a recording medium more excellent in ink-absorbing ability, which can cope with a large amount of ejected ink. Thus, as an ink-jet recording medium excellent in ink-absorbing ability, there has been developed one having a constitution wherein a coated layer having a void structure, i.e., a so-called void type ink-receiving layer is formed by coating on a support, and the recording medium has been mainly applied to a high-definition printing field.

The above void type ink-receiving layer is usually constituted by mainly an inorganic particle and a binder for the inorganic particle. As the inorganic particle, porous inorganic particles, particularly silica and alumina have been frequently employed. For example, Patent Document 1 (JP-A-2001-63205) and Patent Document 2 (JP-A-10-119423) disclose ink-jet recording media having a void type ink-receiving layer wherein silica is used as the inorganic particle and Patent Document 3 (JP-A-11-42848) discloses an ink-jet recording medium having a void type ink-receiving layer wherein alumina is used as the inorganic particle. Since silica is an anionic substance similar to a color material dye contained in the ink, silica shows a bad fixing ability for the ink, so that image density becomes low and also water fastness and humidity fastness are poor. Therefore, in the case where silica is used as a component of the ink-receiving layer, it is necessary to use a cation-modified water-soluble polymer as a binder or to use a cationic polymer or the like in combination. However, the use of such a cationic substance may sometimes invite decrease in ink-absorbing ability and light fastness. On the other hand, alumina is excellent in ink-absorbing ability, fixing ability, and image glossiness in comparison with silica and, depending on mode of usage, a high image quality is obtained as compared with the case where silica is used, so that it is possible to obtain an ink-jet recording medium sufficiently applicable to high-speed printing.

Moreover, as the above support on which the above void type ink-receiving layer is formed by coating, paper is conventionally used. However, in the case where paper is used as the support, a sufficient quality is not obtained in view of gloss, texture, and water fastness and hence it is difficult to obtain highly fine images like silver salt photographs. Accordingly, in recent years, instead of paper supports, resin-coated papers wherein both surfaces of paper are coated with layers of a resin such as a polyolefin resin have been used (e.g., see Patent Document 1) and satisfactory quality even in view of gloss, texture, and water fastness has been obtained.

Therefore, it is said that an ink-jet recording medium having a constitution wherein the aforementioned void type ink-receiving layer using alumina as the inorganic particle is formed by coating on the above resin coated paper is so excellent as to be applicable to high-definition printing uses and high-speed printing.

However, the ink-jet recording medium having a constitution wherein the ink-receiving layer mainly composed of alumina is formed by coating on the resin coated paper results in a problem that cockling (waving of printed surfaces) and/or curl (warp of printed surfaces) occur through impartment of ink during printing on an ink-jet printer and hence paper jam and/or recording head friction where the recording medium comes into contact with a recording head of the printer are apt to occur. The recording head friction may not only stain the resulting recording medium but also break the recording head in the worst case. Furthermore, when deformation of the recording medium, such as cockling and curl, has occurred, apparent texture is remarkably impaired in its entirety of the printed matter even if the image quality itself is still high-quality, so that it is ultimately impossible to obtain a high-quality printed matter.

### DISCLOSURE OF THE INVENTION

Accordingly, an object of the present invention is to provide an ink-jet recording medium which can be suitably used in high-definition printing uses and is applicable to high-speed printing as well as which occurs no printing head friction and is excellent in conveying property on a printer.

The invention has achieved the above object by providing an ink-jet recording medium which comprises: a resin-coated paper comprising a base paper and resin layers with which both surfaces of the base paper are coated, respectively; and an ink-receiving layer formed by coating on one of the resin layers, the ink-receiving layer containing an inorganic particle and a binder for the inorganic particle and the inorganic particle being made of alumina, wherein the base paper has a thickness of 100 to 300 μm and the thickness ratio of one of the resin layers that is located between the base paper and the ink-receiving layer to the other resin layer is as follows: (the one resin layer):(the other resin layer)=1:1 to 1:2.

### BEST MODE FOR CARRYING OUT THE INVENTION

The following will describe the ink-jet recording medium of the present invention in detail.

The ink-jet recording medium of the invention comprises a resin-coated paper comprising a base paper and resin layers with which both surfaces of the base paper are coated, respectively; and an ink-receiving layer formed by coating on one surface of the resin-coated paper.

As the base paper constituting the resin-coated paper according to the invention, paper is preferably used. As a pulp constituting the paper, there may be, for example, mentioned a natural pulp, a recycled pulp, a synthetic pulp, or the like and one of these or a mixture of two or more thereof can be used. Into the paper can be incorporated, if necessary, various additives such as a sizing agent, a paper-strength enhancer, a filler, an antistatic agent, a fluorescent whitening agent, and a dye, which are generally used in paper manufacture. Moreover, the paper may be coated with a surface sizing agent, a surface paper-strength enhancer, a fluorescent whitening agent, an antistatic agent, a dye, an anchoring agent, and the like. Furthermore, the paper may be subjected to a surface smoothing treatment in a usual manner using a calendering apparatus during or after paper-making.

The thickness of the above base paper is 100 to 300 μm, preferably 120 to 250 μm from the viewpoint of a good conveying property on a printer. When the thickness of the base paper is less than 100 μm, rigidity of the ink-jet recording medium is insufficient, so that ideal paper posture for obtaining a good conveying property cannot be maintained after paper weight with a driven roller is removed during running within a printer and hence there is a risk that paper jam and/or recording head friction may occur. Contrarily, when the thickness of the base paper is more than 300 μm, resisting force against the conveying route in the printer increases and there is a risk that defective paper feeding and/or paper jam may occur.

Moreover, the basis weight of the above base paper is preferably 80 to 300 g/m², more preferably 100 to 270 g/m².

As the resin constituting the above resin layer, a polyolefin resin or an electron beam-curable resin capable of being cured with an electron beam can be used. As the polyolefin resin, there may be, for example, mentioned olefin homopolymers such as low-density polyethylene, high-density polyethylene, polypropylene, polybutene, and polypentene, copolymers of two or more olefins, such as ethylene-propylene copolymers, or mixtures thereof. Those having different density and melt index can be used solely or as a mixture. Of these, low-density or high-density polyethylene is particularly preferred in view of texture, strength, water fastness, and cost.

Other components than the above resin, into the above resin layer can be incorporated various additives, e.g., a white pigment such as titanium oxide, zinc oxide, talc, or calcium carbonate, a fatty acid amide such as stearic acid amide or arachidic acid amide, a fatty acid metal salt such as zinc stearate, calcium stearate, aluminum stearate, or magnesium stearate, an antioxidant such as Irganox 1010 or Irganox 1076, a coloring pigment or coloring dye, a fluorescent whitening agent, and a UV absorber, if necessary.

The above resin layer is formed on both surfaces of the above base paper (the above ink-receiving layer-coating surface side and non-coating surface side of the above base paper). In the invention, the thickness ratio of the resin layer that is located between the base paper and the ink-receiving layer (the one resin layer, ink-receiving layer-coating surface side layer) to the resin layer opposite to the one resin layer across the base paper (the other resin layer, ink-receiving layer-non-coating surface side layer) falls within the following range: (the one resin layer):(the other resin layer)=1:1 to 1:2, preferably 1:1.5 to 1:2. Thus, by setting the thickness of the ink-receiving layer-non-coating surface side resin layer to thickness the same as that of the ink-receiving layer-coating surface side resin layer or somewhat thicker than that of the ink-receiving layer-coating surface side layer (a range within a maximum of two times), the ink-jet recording medium can maintain a minus curl posture wherein the surface to be recorded forms a convex shape toward upward and thus paper jam and recording head friction can be effectively prevented before and after the impartment of ink. However, when the thickness of the ink-receiving layer-non-coating surface side resin layer (the other resin layer) is more than two times the thickness of the ink-receiving layer-coating surface side layer (the one resin layer), the degree of the minus curl of the ink-jet recording medium becomes too large and there is a risk that defective paper feeding and/or paper jam may occur.

The thickness of the above ink-receiving layer-coating surface side layer (the one resin layer) is preferably 10 to 25 μm, more preferably 15 to 20 μm.

Moreover, the coating amount of the above ink-receiving layer-coating surface side layer is preferably 10 to 25 g/m², more preferably 15 to 20 g/m² in terms of solid matter.

The thickness of the above ink-receiving layer-non-coating surface side layer (the other resin layer) is preferably 20 to 50 μm, more preferably 20 to 40 μm.

Moreover, the coating amount of the above ink-receiving layer-non-coating surface side layer is preferably 20 to 50 g/m², more preferably 20 to 40 g/m² in terms of solid matter.

In the case where a polyolefin resin is used as a main component of the resin layer, the above resin-coated paper according to the invention comprising the aforementioned base paper and the resin layer can be produced by a so-called extrusion coating process wherein a polyolefin resin melted under heating is cast onto a running base paper. In the case where an electron beam-curable resin is used as a main component of the resin layer, the resin-coated paper can be produced by applying the electron beam-curable resin on the base paper by means of a known coater such as a gravure coater or a blade coater and then irradiating the paper with an electron beam to cure the resin. Regardless of type of the resin layer, before coating the paper with the resin layer, the base paper may be subjected to activation treatment such as corona discharge treatment or flame treatment.

The ink-receiving layer according to the invention is formed by coating on one resin layer of the aforementioned resin-coated paper directly or through another layer(s) such as an anchor coat layer, and is a (porous) so-called void type ink-receiving layer containing an inorganic particle and a binder for the inorganic particle and having a void structure. As the inorganic particle, only alumina is used.

As the inorganic particle in this kind of the void type ink-receiving layer, it is a current situation that silica is frequently used and the use of only alumina is rare. However, since a high image quality is obtained depending on mode of usage in the case of alumina as compared with the case where silica is used and an ink-jet recording medium sufficiently applicable to high-speed printing may be provided, only alumina is used as the inorganic particle in the void type ink-receiving layer in the invention. In this connection, since the coated layer containing a large amount of alumina is apt to decrease in rigidity of the coated layer itself after ink absorption as compared with the coated layer containing a large amount of silica, change in paper posture of the recording medium before and after the ink absorption is large and hence there is a fear of decrease in conveying property of the recording medium on a printer. However, by adopting the resin-coated paper having the aforementioned constitution as a support for the ink-receiving layer containing a large amount of alumina, the ink-jet recording medium of the invention suppresses the change in paper posture of the recording medium before and after the ink absorption as little as possible and thus realizes a good conveying property on a printer.

Alumina to be used in the invention includes α-alumina, transition alumina (alumina containing γ, δ, θ-alumina as main phases), boehmite, pseudo boehmite, diaspore, gibbsite, bayerite, amorphous alumina, and the like, and one or more thereof may be used solely or two or more thereof may be used in combination. Of the alumina, particularly boehmite, pseudo boehmite, and α-alumina have a suitable pore diameter capable of imparting a good ink-absorbing ability to the ink-receiving layer, so that they are preferably used in the invention.

The average primary particle diameter of alumina to be used in the invention is preferably 3 to 50 nm, more preferably 3 to 30 nm from the viewpoint of the balance between the ink-absorbing ability of the ink-receiving layer and the surface glossiness and coloring ability. The average primary particle diameter of alumina can be measured using a scanning electron microscope (SEM) or a transmission electron microscope (TEM).

Moreover, the average pore diameter of alumina to be used in the invention is preferably 3 to 20 nm, more preferably 3 to 15 nm from the viewpoint of imparting a good ink-absorbing ability to the ink-receiving layer. However, the average pore diameter of alumina in an ink-receiving layer having a two-layered constitution (an ink-receiving layer consisting of an upper layer and a lower layer) to be mentioned below is not limited thereto. The average pore diameter of alumina can be measured by the mercury-injection method.

The content of alumina is preferably 70 to 97% by weight, more preferably 75 to 95% by weight based on the weight of the total solid matter in the ink-receiving layer. When the content of alumina is less than 70% by weight, there is a possibility that an ink-absorbing ability is insufficient and a good image quality is not obtained. Contrarily, when the content exceeds 97%, there is a risk that the strength of the coated film of the ink-receiving layer is deficient and hence inconveniences such as powder-dropping may occur.

As the above binder for alumina to be used in the ink-receiving layer according to the invention, a water-soluble or water-insoluble polymer compound having affinity to ink can be incorporated. Specifically, there may be, for example, mentioned cellulose-based adhesives such as methylcellulose, methyl hydroxyethylcellulose, methyl hydroxypropylcellulose, and hydroxyethylcellulose, natural polymer resins such as starch and modified products thereof, gelatin and modified products thereof, casein, pullulan, gum arabic, and albumin, or derivatives thereof, latexes and emulsions such as polyvinyl alcohol and modified products thereof, styrene-butadiene copolymers, styrene-acryl copolymers, methyl methacrylate-butadiene copolymers, and ethylene-vinyl acetate copolymers, vinyl polymers such as polyacrylamide and polyvinylpyrrolidone, polyethyleneimine, polypropylene glycol, polyethylene glycol, and maleic anhydride or copolymers thereof, vinylpyrrolidone/vinyl acetate copolymers, and acetal resins such as polyvinyl butyral and polyvinyl formal. There may be used one of these solely or two or more thereof as a mixture.

Preferred as the above binder are polyvinyl alcohol and a modified product thereof (a modified polyvinyl alcohol) and particularly, a polyvinyl alcohol having a saponification degree of 75 to 98 mol % and an average polymerization degree of 500 to 5,000 and a modified product thereof are preferred. As the modified product, cation-modified products and silanol-modified products may be mentioned. Such polyvinyl alcohol and the like can increase layer strength by adding a relatively small amount thereof without inhibiting aqueous ink-absorbing ability of the ink-receiving layer.

The content of the above binder is preferably 3 to 30 parts by weight, more preferably 5 to 25 parts by weight based on 100 parts by weight of alumina contained in the above ink-receiving layer from the viewpoint of the balance between the strength of the coated film and the ink-absorbing ability of the ink-receiving layer. In general, in the case where only silica is used as the inorganic particle to be incorporated in the void type ink-receiving layer, the content of the binder for silica is frequently adjusted to the range of 10 to 100 parts by weight based on 100 parts by weight of silica and the content of the binder tends to increase as compared with the case where only alumina is used as the inorganic particle. However, when the content of the binder for alumina exceeds a certain amount, there is a risk that the pores of alumina are filled with the binder and an excellent ink-absorbing ability possessed by alumina cannot be sufficiently exhibited. Thus, in the invention, preferred content of the binder for alumina is set at the above range which is smaller than the content of usual binder in the ink-receiving layer in which only silica is used as the inorganic particle.

Into the ink-receiving layer according to the invention can be suitably incorporated, in addition to the above alumina and binder, various additives such as a crosslinking agent, an ink-fixing agent (a cationic substance), a pigment dispersant, a thickening agent, a flow improver, a deforming agent, a form inhibitor, a releasing agent, a foaming agent, a penetrant, a coloring dye, a coloring pigment, a fluorescent whitening agent, a UV absorber, an antioxidant, an antiseptic, an antifungal agent, and the like, if necessary.

The ink-receiving layer according to the invention can be formed on the above resin-coated paper by applying a coating solution containing the above various components by a known coating method, followed by drying.

The coating amount of the ink-receiving layer according to the invention is preferably 20 to 70 g/m², more preferably 30 to 50 g/m² in terms of solid matter from the viewpoint of the balance between the ink-absorbing ability and the powder-dropping prevention. The thickness of the ink-receiving layer is preferably 20 to 70 μm, more preferably 30 to 50 μm. In the case where only alumina is used as the inorganic particle to be incorporated in the void type ink-receiving layer, the content of the binder for alumina is preferably set at an amount smaller than the content of the binder for silica in the case where only silica is used as the inorganic particle but at such content, there is a risk that a problem of insufficient ink-absorbing ability and the like may occur. Thus, in the invention, for the purpose of compensating the deficiency of the binder, the coating amount of the ink-receiving layer is set at the above range that is larger than the usual coating amount of the ink-receiving layer in which only silica is used as the inorganic particle.

The ink-receiving layer according to the invention (ink-receiving layer which contains an inorganic particle and a binder for the inorganic particle and where the inorganic particle is made of alumina) may be a monolayer structure having a single composition or may be a constitution wherein multi-layers different in composition are laminated. As a particularly preferred ink-receiving layer, there may be mentioned an ink-receiving layer having a bilayer constitution wherein lower and upper layers containing the above alumina (inorganic particle) and the binder for alumina are sequentially laminated on one of the above resin layers of the above resin-coated paper (ink-receiving layer-coating side resin layer). The upper layer is a top layer of the ink-receiving layer and is a layer to which the ink ejected from the recording head is deposited at ink-jet recording. The following will describe the ink-receiving layer having the bilayer constitution.

Both of the above upper and lower layers contain two kinds of alumina different in average pore diameter. The two kinds of alumina are “alumina having an average pore diameter of less than 5 nm (preferably 2 to 4 nm)” (hereinafter referred to as alumina A) and “alumina having an average pore diameter of 5 nm or more (preferably 5 to 15 nm)” (hereinafter referred to as alumina B). With regard to alumina A and alumina B, the difference in average pore diameter [(average pore diameter of alumina B)−(average pore diameter of alumina A)] is preferably 1 nm or more. The average pore diameter of alumina can be determined by the mercury-injection method.

From the view point of the balance between the prevention of bleeding of printed parts and the color-developing property of the printed parts and the conveying property on a printer, the content ratio of alumina A to alumina B in the upper layer is as follows: (alumina A):(alumina B)=100:0 to 70:30, preferably (alumina A):(alumina B)=100:0 to 75:25 in a weight ratio.

Moreover, from the same viewpoint as in the upper layer, the content ratio of alumina A to alumina B in the lower layer is as follows: (alumina A):(alumina B)=0:100 to 50:50, preferably (alumina A):(alumina B)=0:100 to 45:55 in a weight ratio.

Thus, since the upper layer is mainly composed of alumina A having a relatively small average pore diameter, the layer predominantly acts on the fixing of ink color materials and can fix minute ink color materials such as magenta and yellow dyes. On the other hand, since the lower layer is mainly composed of alumina B having a relatively large average pore diameter, the layer predominantly acts on absorption and penetration of an ink solvent. Namely, a function as a fixing layer of the ink color materials is imparted to the upper layer and a function as an absorbing layer of the ink solvent is imparted to the lower layer. Thus, owing to the overall action of such upper and lower layers, the ink-jet recording medium of the invention is excellent in quick-drying of ink, so that the deposited ink is absorbed and also the ink color materials and ink solvent constituting the ink can be retained separately in the upper and lower layers, respectively, resulting in no retention of the ink solvent on the upper layer in which the ink color materials are fixed. Therefore, even when the ink solvent is swollen and diffused by the influence of humidity change or the like, the ink color materials fixed in the upper layer is affected only a little and, as a result, bleeding of printed parts is effectively suppressed. Accordingly, the ink-jet recording medium of the invention having the above ink-receiving layer of a bilayer constitution induces no bleeding of printed parts even when it is stored in an album or two or more sheets thereof are allowed to stand in an overlaid state at a stage where not so long time has passed after completion of printing, so that the recording medium is excellent in handling property after printing. Moreover, the adoption of the upper and lower layers having such constitutions is also effective in that not only color development of the printed parts is enhanced and a high image quality is obtained but also suitable paper posture is maintained, deformation such as curl hardly occurs, paper-feeding error, multiple feeding, paper jam, and recording head friction are not induced, and thus a good conveying property on a printer is obtained.

However, in order to surely exhibit fixing action of the ink color materials by the upper layer and penetration-accelerating action of the ink solvent by the lower layer and effectively prevent bleeding of the printed parts after printing as mentioned above, the thickness ratio of the upper layer to the lower layer should be as follows: (upper layer):(lower layer)=2:1 to 5:1, preferably (upper layer):(lower layer)=2.5:1 to 3.5:1. When the thickness ratio falls out of such a range, the bleeding after printing cannot be effectively prevented.

By adopting the above ink-receiving layer having the bilayer constitution, it becomes possible to solve the following problems of the conventional ink-jet recording medium.

Namely, with regard to the conventional ink-jet recording media, the bleeding of the printed parts (ink deposited parts) immediately after ink deposition is improved but there arise problems of occurrence of bleeding of the printed parts and remarkable decrease in image grade when the recording medium is stored in an album or two or more sheets thereof are allowed to stand in an overlaid state under a condition immediately after the ink deposition or under a condition (semi-dried condition) where about 5 minutes has passed after the ink deposition and the deposited ink is not completely dried but apparently dried. The cause of bleeding of the printed parts which occurs after printing is not clear but seems to be attributable to the following: the ink solvent absorbed in the ink-receiving layer is swollen and diffused within the ink-receiving layer by the influence of humidity change or the like and, as a result, the ink color materials once fixed in the ink-receiving layer migrate by the action of the swollen and diffused ink solvent.

Even in the case where printing is performed using an ink-jet recording medium having the above problem, it is possible to suppress the bleeding of the printed parts when handling after printing is performed with utmost caution, for example, the medium is stored in album after the deposited ink is almost completely dried. However, the complete drying of the printing ink usually requires a relatively long period of time and it is very troublesome to pay attention over a long time so as not to cause bleeding on the printed parts. Therefore, users have desired an ink-jet recording medium which hardly induces bleeding on the printed parts after printing and is excellent in handling property after printing.

The thickness of the upper layer is preferably 30 to 60 μm, more preferably 30 to 45 μm. Moreover, the coating amount of the upper layer is preferably 30 to 60 g/m², more preferably 30 to 45 g/m² in terms of solid matter.

The thickness of the lower layer is preferably 10 to 20 μm, more preferably 10 to 15 μm. Moreover, the coating amount of the lower layer is preferably 10 to 20 g/m², more preferably 10 to 15 g/m² in terms of solid matter.

Furthermore, the alumina content in both of the upper and lower layers is preferably 70 to 97% by weight, more preferably 75 to 95% by weight based on the total weight of the solid matter in the upper and lower layers. When the alumina content is less than 70% by weight, there is a possibility that ink-absorbing ability is insufficient and a good image quality is not obtained, while when the content is more than 97% by weight, there is a risk that strength of the coated film is deficient and inconvenience such as powder-dropping may occur.

As the binder for alumina to be used in the upper and lower layers, the aforementioned binders can be employed.

Moreover, the content of the above binder in both of the upper and lower layers is preferably 3 to 30 parts by weight, more preferably 5 to 20 parts by weight based on 100 parts by weight of alumina contained in the layers from the viewpoint of the balance between the strength of the coated film and the ink-absorbing ability of the ink-receiving layer. The reason why preferred content of the binder for alumina is set at the above range which is smaller than the content of usual binder in the ink-receiving layer in which only silica is used as the inorganic particle is as mentioned above.

Into each of the upper and lower layers can be suitably incorporated, in addition to the above alumina and binder, various additives such as a crosslinking agent, an ink-fixing agent (a cationic substance), a pigment dispersant, a thickening agent, a flow improver, a deforming agent, a form inhibitor, a releasing agent, a foaming agent, a penetrant, a coloring dye, a coloring pigment, a fluorescent whitening agent, a UV absorber, an antioxidant, an antiseptic, an antifungal agent, and the like, if necessary.

The ink-receiving layer composed of the two layers of the aforementioned upper and lower layers according to the invention can be formed on one of the above resin layers of the above resin-coated paper by applying a lower layer coating solution containing the above various components by a known coating method, followed by drying, and subsequently applying an upper layer coating solution containing the above various components by a known coating method, followed by drying.

The ink-jet recording medium of the invention is not limited to the aforementioned constitution, i.e., the constitution wherein an ink-receiving layer is formed on and adjacently to one of the resin layers of the resin-coated paper where both surfaces of the base paper are coated with the resin layers, and can be variously changed without departing from the gist of the invention.

For example, between the one resin layer constituting the resin-coat paper (ink-receiving layer-coating side resin layer) and the ink-receiving layer, an anchor coat layer for increasing adhesion of both layers may be formed by coating. Moreover, on the other resin layer (ink-receiving layer-non-coating side resin layer) in the above resin-coated paper, a back coat layer may be formed by coating for the purpose of slip prevention and charging prevention at conveying within a printer.

### EXAMPLES

The present invention will be described more specifically with reference to Examples of the invention and Test Examples showing advantages of the invention, but the invention should not be construed as being limited thereto.

### (Preparation of Coating Solution for Ink-Receiving Layer)

A coating solution for an ink-receiving layer having the following composition was prepared.

Alumina (pseudo voehmite powder, average primary particle diameter of 15 nm): 12% by weight

Binder (manufactured by Kuraray Co., Ltd., PVA235): 2.2% by weight

(polyvinyl alcohol, saponification degree of 88 mol %, average polymerization degree of 3,500)

Cation polymer: 0.5% by weight

(manufactured by Dai-Ichi Kogyo Seiyaku Co., Ltd., Sharol DC902P, 51.5% aqueous solution)

Boric acid (crosslinking agent): 0.5% by weight

Polyoxyethylene lauryl ether (surfactant): 0.03% by weight

(manufactured by Kao Corp., Emulgen 109P, 10% aqueous solution)

Ion-exchanged water: balance
Total 100% by weight

### Example 1

A slurry is obtained by adding 0.5 part by weight of epoxydated behenamide, 1.0 part by weight of anionic polyacrylamide, 0.1 part by weight of polyamide polyamine epichlorhydrin, and 0.5 part by weight of cationic polyacrylamide to 100 parts by weight of LBKP pulp having a beating degree of 300 ml csf, each as an absolute dry weight ratio to the pulp. Then, the slurry was subjected to Fourdrinier machine to make a base paper of 170 g/m². Furthermore, in order to adjust surface size of the base paper, 0.04% by weight of a fluorescent whitening agent (manufactured by Sumitomo Chemical Co., Ltd., Whitex BB) was added to a 4% aqueous polyvinyl alcohol solution and then the base paper was impregnated with the resulting solution in an amount of 0.5 g/m² in terms of absolute dry weight. After drying, the paper was further subjected to calender treatment to obtain a base paper having a thickness of 150 μm, density of which was adjusted to 1.05 g/ml.

After the wire surface (reverse) side of the thus obtained base paper was subjected to a corona discharge treatment, the whole surface of the corona-discharged surface was homogeneously coated with high-density polyethylene using a melt extruder to form a resin layer (the other resin layer, ink-receiving layer-non-coating side resin layer) having a thickness of 36 μm. Furthermore, after the surface of the ink-receiving layer-non-coating side resin layer was subjected to a corona discharge treatment, a dispersion (antistatic agent) containing aluminum oxide (manufactured by Nissan Chemical Industries, Ltd., Alumina Sol 100) and silicon dioxide (manufactured by Nissan Chemical Industries, Ltd., Snowtex O) dispersed in water in a weight ratio of 1:2 were applied onto the corona-discharged surface in an amount of 0.2 g/m² as dry weight.

Then, after the felt surface (front) side of the above base paper was subjected to a corona discharge treatment, the whole surface of the corona-discharged surface was homogeneously coated with low-density polyethylene having an MFR (melt flow rate) of 3.8 using a melt extruder to form a resin layer (the one resin layer, ink-receiving layer-coating side resin layer) having a thickness of 18 μm. In this connection, the low-density polyethylene used here contains anatase-type titanium dioxide in an amount of 10% by weight based on polyethylene, a fluorescent whitening agent in an amount of 0.01% by weight based on polyethylene, and a minute amount of ultramarine.

Furthermore, polyallylamine (manufactured by Nitto Boseki Co., Ltd.) as a mordant was applied in an amount of 0.6 g/m² on the above ink-receiving layer-coating side resin layer and dried to form an anchor coat layer (mordant-containing layer).

Thus, a resin-coated paper with an anchor coat layer wherein both surfaces of the base paper were coated with resin layers was produced.

The above coating solution for an ink-receiving layer was applied on the above anchor coat layer of the above resin-coated paper and dried so that a coating amount after drying was 40 g/m², thereby forming a void type ink-receiving layer having a thickness of 40 μm.

The ink-jet recording medium obtained by the above procedure was used as a sample of Example 1.

### Examples 2 to 4 and Comparative Examples 1 to 4

Ink-jet recording media were produced in the same manner as in Example 1 except that the thickness of each of the base paper and the resin layers (ink-receiving layer-coating side resin layer, ink-receiving layer-non-coating side resin layer) constituting the resin-coated paper in Example 1 was variously changed as shown in the following [Table 2]. They were used as samples of Examples 2 to 4 and Comparative Examples 1 to 4.

### Test Example 1

With regard to each of the samples of the ink-jet recording media of Examples 2 to 4 and Comparative Examples 1 to 4, the paper posture, conveying property, and recording head friction were evaluated by the following methods, respectively. The evaluation results thereof are shown in the following [Table 2].

### (Evaluation Method of Paper Posture)

The above sample having an A4 size was allowed to stand in an environment of a room temperature of 25° C. and a relative humidity of 60% RH for 24 hours. Then, the sample was placed on a flat table with the surface to be recorded (surface of the ink-receiving layer) upward and the height of four corners and four sides of the sample from the surface of the table at this time was measured and the maximum value of these measured values was regarded as a maximum value at a plus side. Also, contrarily, the sample was placed on the table with the surface to be recorded downward and the height of four corners and four sides of the sample from the surface of the table at this time was measured and the maximum value of these measured values was regarded as a maximum value at a minus side. In addition, the sum of the maximum value at the plus side and the maximum value at the minus side was used as a paper posture range, and ranking as shown in the following [Table 1] was performed.

TABLE 1

| | | Paper posture | |
|---|---|---|---|
| Maximum value | Maximum value in | range | |
| in plus side (A) | minus side (B) | (A) and (B) | Ranking |
| 0 mm to 1 mm | 0 mm to 10 mm | 11 mm or less | A |
| more than 1 mm to | more than 10 mm | 17 mm or less | B |
| 2 mm or less | to 15 mm or less | | |
| more than 2 mm to | more than 15 mm | 24 mm or less | C |
| 4 mm or less | to 20 mm or less | | (practical |
| | | | limit) |
| more than 4 mm | more than 20 mm | more than 24 mm | D |

### (Evaluation Method of Conveying Property)

Twenty sheets of the above sample having an A4 size were set in a paper-feeding tray of an ink-jet printer (manufactured by Seiko Epson Corporation, PM-A900) in a laminated state and the sample sheets were sequentially fed by acting a paper-feeding mechanism of the printer. The operation was repeated ten times (passed sheets: 200 sheets) and the number of times of paper-feeding error (paper is not picked up from the paper-feeding tray), multiple feeding (a plurality of sheets are undesirably fed), and paper jam (paper is jammed inside the printer and becomes impossible to feed) which occurred during the operation was counted. The sample where the rate of occurrence thereof [{(total number of occurrence of paper-feeding error, multiple feeding, and paper jam)/200}×100] was less than 1% was ranked as A (good conveying property), the sample where the rate of occurrence of defective paper-feeding was from 1% to less than 2% as B, the sample where the rate of occurrence of defective paper-feeding was from 2% to less than 3% as C (practical limit level), and the sample where the rate of occurrence of defective paper-feeding was 3% or more as D.

### (Evaluation Method of Recording Head Friction)

After the above sample having an A4 size was allowed to stand in an environment of a room temperature of 25° C. and a relative humidity of 60% RH, highly fine color digital standard images (ISO JIS/SCID images N1 to N8) were printed on the surface to be recorded of the sample with four-side borderless printing using an ink-jet printer (manufactured by Seiko Epson Corporation, PM-A900). The surface to be recorded after printing was visually observed and the sample where the rate of strain deposition [{(total area of stain deposited parts on surface to be recorded)/(total area of surface to be recorded}×100] was 0% was ranked as A, the sample where the rate was less than 2% as B, the sample where the rate was more than 2% to 3% or less as C (practical limit level), and the sample where the rate was more than 3% as D.

TABLE 2

| | Resin-coated paper | | | | | | |
|---|---|---|---|---|---|---|---|
| | | | Thickness of | | | | |
| | | Thickness of | ink-receiving | | | | |
| | Thickness | ink-receiving | layer-non- | Thickness | | | |
| | of base | layer-coating | coating side | ratio of | | | Recording |
| | paper | side resin layer | resin layer (B) | resin layers | Paper | Conveying | head |
| | (μm) | (A) (μm) | (μm) | (A):(B) | posture | property | friction |
| Ex. 1 | 150 | 18 | 36 | 1:2 | A | A | A |
| Ex. 2 | 200 | 20 | 20 | 1:1 | B | C | B |
| Ex. 3 | 150 | 16 | 24 | 1:1.5 | A | A | A |
| Ex. 4 | 150 | 15 | 15 | 1:1 | B | A | B |
| Comp. | 150 | 20 | 10 | 2:1 | D | D | D |
| Ex. 1 | | | | | | | |
| Comp. | 200 | 20 | 45 | 1:2.25 | C | D | B |
| Ex. 2 | | | | | | | |
| Comp. | 80 | 18 | 36 | 1:2 | D | A | D |
| Ex. 3 | | | | | | | |
| Comp. | 320 | 18 | 36 | 1:2 | C | D | D |
| Ex. 4 | | | | | | | |

### Example 5

An upper layer coating solution and a lower layer coating solution each having the following composition were prepared. Then, on the above anchor coat layer of the resin-coated paper used in Example 1 was applied and dried the lower layer coating solution so that a coating amount after drying was 10 g/m². Thereafter, the upper layer coating solution was applied and dried so that a coating amount after drying was 30 g/m². Thus, on the resin-coated paper was applied an ink-receiving layer of a bilayer constitution comprising a lower layer having a thickness of 10 μm and an upper layer having a thickness of 30 μm sequentially laminated thereon.

The ink-jet recording medium obtained by the above procedure was used as a sample of Example 5.

### <Composition of Upper Layer Coating Solution>

Alumina A (manufactured by Catalysts & Chemicals Ind. Co., Ltd., Cataloid AS-3): 10% by weight

(average primary particle diameter of 10 nm, average pore diameter of 3.3 nm)

Binder (manufactured by Kuraray Co., Ltd., PVA235): 2% by weight

(polyvinyl alcohol, saponification degree of 88 mol %, average polymerization degree of 3,500)

Cation Polymer: 0.5% by weight

(manufactured by Dai-Ichi Kogyo Seiyaku Co., Ltd., Sharol DC902P, 51.5% aqueous solution)

Boric acid (crosslinking agent): 0.5% by weight

Polyoxyethylene lauryl ether (surfactant): 0.03% by weight

(manufactured by Kao Corp., Emulgen 109P, 10% aqueous solution)

Ion-exchanged water: balance
Total 100% by weight

### <Composition of Lower Layer Coating Solution>

Alumina B (manufactured by the following production method): 10% by weight

(average primary particle diameter of 30 nm, average pore diameter of 7.1 nm)

Binder (manufactured by Kuraray Co., Ltd., PVA235): 2% by weight

(polyvinyl alcohol, saponification degree of 88 mol %, average polymerization degree of 3,500)

Cation Polymer: 0.5% by weight

(manufactured by Dai-Ichi Kogyo Seiyaku Co., Ltd., Sharol DC902P, 51.5% aqueous solution)

Boric acid (crosslinking agent): 0.5% by weight

Polyoxyethylene lauryl ether (surfactant): 0.03% by weight

(manufactured by Kao Corp., Emulgen 109P, 10% aqueous solution)

Ion-exchanged water: balance
Total 100% by weight

### (Production Method of Alumina B)

Into a 3 L reactor were charged 1200 g of ion-exchanged water and 900 g of isopropyl alcohol, followed by heating at 75° C. Thereto was added 408 g of aluminum isopropoxide. The whole was heated at 75° C. for 24 hours and then hydrolysis was further performed at 95° C. for 10 hours. After hydrolysis, 24 g of acetic acid was added and the whole was stirred at 95° C. for 48 hours. Then, the mixture was concentrated so that solid matter concentration becomes 15% by weight, thereby a dispersion (sol) of alumina hydrate being obtained. The sol was dried at room temperature and, upon X-ray diffraction measurement, the sol showed a pseudo boehmite structure. Moreover, when its average primary particle diameter was measured using TEM, it was 30 nm and the particle has a flat shape having an aspect ratio of 6.0. Furthermore, its average pore diameter was 7.1 nm when measured by the mercury-injection method.

### Examples 6 to 15

Ink-jet recording media were produced in the same manner as in Example 5 except that the ratio of alumina A to alumina B contained in the upper layer and/or the lower layer and the thickness of the upper layer and/or the lower layer in Example 5 were variously changed. They were used as samples of Examples 6 to 15.

### Test Example 2

With regard to each sample of the thus obtained ink-jet recording media of Examples 5 to 15, bleeding of printed parts immediately after printing (initial bleeding), bleeding of printed parts at the time when a certain time had passed after completion of printing (bleeding with time), and a color developing property were evaluated by the following methods, respectively. The evaluation results thereof are shown in the following Table 3.

(Evaluation Methods of Initial Bleeding, Bleeding with Time, and Color Developing Property)

Each of the above samples was set on an ink-jet printer (manufactured by Seiko Epson Corporation, PM-A900) and a highly fine color digital standard image [(ISO/JIS-SCID), an image name “portrait” (sample number 1, evaluation recognition number N1 of the image)] was printed on the surface of ink-receiving layer of the sample with “recommended beautiful mode”.

The printed surface of the printed matter thus prepared was visually observed immediately after printing and the sample where no bleeding (phenomena of color bleeding or heterogeneous mixing of colors at heterochromatic boundary parts) was observed at the printed parts was ranked as A (good initial bleeding-preventing property), the sample where the bleeding was slightly observed was ranked as B, and the case where the bleeding was remarkably observed was ranked as C.

Moreover, after each of the above samples were allowed to stand in an environment of a room temperature of 25° C. and a relative humidity of 60% RH for 24 hours, the above portrait was printed under the same conditions as above in the above environment. Then, after the printed matter immediately after printing was allowed to stand for one day in a state that it was stored in a clear file so as to enable visual observation of the printed surface from the outside, the surface was visually observed. The sample where no bleeding was observed at the printed parts was ranked as A (good preventing property against bleeding with time), the sample where the bleeding was slightly observed was ranked as B, and the sample where the bleeding was remarkably observed was ranked as C.

Furthermore, after the above printed matter was allowed to stand in a constant-temperature and constant-humidity chamber set at a room temperature of 23° C. and a relative humidity of 50% RH for 24 hours, reflective optical density (OD value) on duty 100% parts of each color of cyan (C), magenta (M), yellow (Y), and black (K) was measured under conditions of a viewing angle of 2°, a light source of D50, and no filter using a spectrolino SPM-50 manufactured by GretagMacbeth AG. The sample where the sum of the OD values of CMYK exceeds 7.5 was ranked as A (dense image density and good color-developing property), the sample where the sum falled within the range of 7.5 to 6.0 was ranked as B, and the case where the sum was less than 6.0 (OD value of less than 1.5 on average) was ranked as C.

TABLE 3

| | Ink-receiving layer | | | | | | | |
|---|---|---|---|---|---|---|---|---|
| | Upper layer | | Lower layer | | Thickness | | | |
| | Alumina A:alumina B | Thickness | Alumina A:alumina B | Thickness | ratio of upper | | | Color |
| | (weight | (A) | (weight | (B) | layer to lower | Initial | Bleeding | developing |
| | ratio) | (μm) | ratio) | (μm) | layer (A):(B) | bleeding | with time | property |
| Example 5 | 100:0 | 30 | 0:100 | 10 | 3:1 | A | B | A |
| Example 6 | 90:10 | 30 | 0:100 | 15 | 2:1 | A | B | A |
| Example 7 | 80:20 | 30 | 50:50 | 10 | 3:1 | A | A | A |
| Example 8 | 70:30 | 30 | 50:50 | 10 | 3:1 | A | B | A |
| Example 9 | 100:0 | 60 | 0:100 | 12 | 5:1 | A | A | A |
| Example | 100:0 | 10 | 0:100 | 30 | 1:3 | A | C | A |
| 10 | | | | | | | | |
| Example | 90:10 | 20 | 0:100 | 20 | 1:1 | A | C | A |
| 11 | | | | | | | | |
| Example | 100:0 | 10 | 0:100 | 10 | 1:1 | C | C | A |
| 12 | | | | | | | | |
| Example | 100:0 | 55 | 0:100 | 10 | 5.5:1 | A | A | A |
| 13 | | | | | | | | |
| Example | 65:35 | 30 | 0:100 | 10 | 3:1 | A | C | A |
| 14 | | | | | | | | |
| Example | 100:0 | 30 | 55:45 | 10 | 3:1 | A | A | A |
| 15 | | | | | | | | |

Alumina A: average pore diameter of 3.3 nm
Alumina B: average pore diameter of 7.1 nm

### INDUSTRIAL APPLICABILITY

In the ink-jet recording medium of the present invention, since the thickness of the above base paper constituting the above resin-coated paper (support) is adjusted to the above specific range and also the thickness ratio of the above resin layers which coat the both surface of the base paper is adjusted to the above specific range, change of the paper posture before and after ink impartment is suppressed, cockling and curl hardly occur, and thus the conveying property on a printer is excellent. Moreover, since the ink-jet recording medium of the invention uses alumina as the inorganic particle constituting a void type ink-receiving layer, a good image quality can be stably obtained even at high-speed printing, so that the medium can be suitably used in high-definition printing uses such as silver salt photography.

1. An ink-jet recording medium which comprises: a resin-coated paper comprising a base paper and resin layers with which both surfaces of the base paper are coated, respectively; and an ink-receiving layer formed by coating on one of the resin layers, the ink-receiving layer containing an inorganic particle and a binder for the inorganic particle and the inorganic particle being made of alumina,
wherein the base paper has a thickness of 100 to 300 μm, and the thickness ratio of one of the resin layers that is located between the base paper and the ink-receiving layer to the other resin layer is as follows: (the one resin layer):(the other resin layer)=1:1 to 1:2.

2. The ink-jet recording medium according to claim 1, wherein the one resin layers has a thickness of from 10 to 25 μm and the other resin layers has a thickness of from 20 to 50 μm.

3. The ink-jet recording medium according to claim 1, wherein the content of the binder is 3 to 30 parts by weight based on 100 parts by weight of the alumina.

4. The ink-jet recording medium according to claim 1, wherein the coating amount of the ink-receiving layer is 20 to 70 g/m² in terms of solid matter.

5. The ink-jet recording medium according to claim 1, wherein the ink-receiving layer is formed by sequentially laminating an lower layer and an upper layer on one of the resin layers of the resin-coated paper,
wherein the upper layer contains, as the alumina, alumina having an average pore diameter of less than 5 nm (alumina A) and alumina having an average pore diameter of 5 nm or more (alumina B) in a weight ratio of (alumina A):(alumina B)=100:0 to 70:30,
wherein the lower layer contains, as the alumina, the alumina A and the alumina B in a weight ratio of (alumina A):(alumina B)=0:100 to 50:50, and
wherein the thickness ratio of the upper layer to the lower layer is as follows: (upper layer):(lower layer)=2:1 to 5:1.

6. The ink-jet recording medium according to claim 5, wherein the upper layer has a thickness of 30 to 60 μm and the lower layer has a thickness of from 10 to 20 μm.

7. The ink-jet recording medium according to claim 5, wherein the content of the binder in each of the upper layer and the lower layer is 3 to 30 parts by weight based on 100 parts by weight of the alumina.
